(19) United States
(12) Patent Application Publication
(10) Pub. No.: US 2016/0160793 A1
(43) Pub. Date: Jun. 9, 2016

(54) ENGINE FOR VEHICLES

(71) Applicant: Hyundai Motor Company, Seoul (KR)

(72) Inventor: Jang Hun KIM, Suwon-si (KR)

(73) Assignee: Hyundai Motor Company, Seoul (KR)

(21) Appl. No.: 14/712,642

(22) Filed: May 14, 2015

(30) Foreign Application Priority Data
Dec. 4, 2014 (KR) 10-2014-0172816

(51) Int. Cl. F02F 3/14; F02F 1/00; F02F 3/22; F02F 1/40

(52) U.S. Cl. CPC F02F 3/14; F02F 1/40; F02F 1/004; F02F 3/22

(57) ABSTRACT

An engine for vehicles may include a piston provided to be moved up and down within a cylinder, and a cylinder head disposed over an upper portion of the piston to form a combustion chamber together with the piston. An upper surface of a head of the piston and an inner side wall of the cylinder head may be provided with a coating film made of a material having a higher thermal conductivity at a lower temperature and a lower thermal conductivity at a higher temperature. The coating film increases heat transfer at an intake or compression stroke when temperature in the combustion chamber decreases and reduces heat transfer at an explosion or exhaust stroke when the temperature in the combustion chamber increases.

### CROSS-REFERENCE TO RELATED APPLICATION

The present application claims priority of Korean Patent Application Number 10-2014-0172816 filed on Dec. 4, 2014, the entire contents of which are incorporated herein for all purposes by this reference.

### BACKGROUND OF INVENTION

1. Field of Invention

The present invention relates to an engine for vehicles, and more particularly, to an engine for vehicles capable of radiating and insulating heat in a combustion chamber depending on a temperature condition of an engine combustion chamber.

2. Description of Related Art

A cylinder has a cylindrical shape having a length about twice as large as a piston stroke, and therefore is a subject of an apparatus in which a piston reciprocates while keeping air tightness to change heat energy to mechanical energy, thereby generating required power.

As such, to obtain power as high as possible from the given heat energy, a compressed mixture or combusted explosive gas needs to be prevented from being leaked between the cylinder and the piston, and at the same time, friction and abrasion due to a contact of the piston and an inside of the cylinder need to be small. In particular, the cylinder is exposed to the high-temperature combustion gas of 2000° C. or more during an operation of the cylinder, and therefore to prevent a function of the cylinder from reducing, there is a need to prevent the temperature of the cylinder from increasing to a predetermined or more.

For this purpose, an air cooling type which cools the cylinder by forming a cooling fin around the cylinder and passing fresh air therethrough is used or a water cooling type which cools the cylinder by forming a water jacket on the cylinder and circulating low-temperature cooling water has been applied.

Meanwhile, the piston applied with a heat load by the combustion gas which is exploded inside the combustion chamber is configured to include a crown positioned at an upper portion and a skirt positioned at a lower portion thereof and uses lubricating oil to cool the crown and is configured to make the lubricating oil flow from an external gallery of the piston to an internal gallery thereof. A passage of the lubricating oil flowing from the external gallery to the internal gallery is called a cooling passage and the cooling of the piston is determined depending on the position of the cooling passage.

However, the existing engine combustion chamber has remaining heat after an expansion/exhaust stroke at the time of an intake stroke, and thus filling efficiency may be aggravated due to high heat capacity.

Further, at the time of the expansion stroke, overheat due to high temperature and high pressure combustion gas is excessively delivered to a cylinder head and the piston and thus the temperature of the cooling water cooling the cylinder head and the temperature of the lubricating oil cooling the piston suddenly rise, such that the temperature of the cooling water and the temperature of the lubricating oil need to be lowered again, thereby causing a cooling loss.

That is, as illustrated in FIG. 1, the combustion gas is in a low temperature/low pressure state at the time of the intake stroke and the compression stroke and the combustion gas is in the high temperature/high pressure state at the time of the explosion stroke and the exhaust stroke. As the temperature condition of the combustion chamber is not considered, the filling efficiency is reduced and the cooling loss occurs, thereby reducing the fuel efficiency and reducing the torque.

The information disclosed in this Background section is only for enhancement of understanding of the general background of the invention and should not be taken as an acknowledgement or any form of suggestion that this information forms the prior art already known to a person skilled in the art.

### SUMMARY OF THE INVENTION

The present invention is directed to transferring and insulating heat depending on a temperature of an engine combustion chamber. That is, the present invention is directed to an engine for vehicles capable of improving filling efficiency under a condition in which temperature in an engine combustion chamber is lower and improving cooling efficiency under a condition in which temperature in an engine combustion chamber is higher.

Other objects and advantages of the present invention can be understood by the following description, and become apparent with reference to the embodiments of the present invention. Also, it is obvious to those skilled in the art to which the present invention pertains that the objects and advantages of the present invention can be realized by the means as claimed and combinations thereof.

In accordance with various aspects of the present invention, an engine for vehicles includes: a piston provided to be moved up and down within a cylinder; and a cylinder head disposed over an upper portion of the piston to form a combustion chamber together with the piston, wherein an upper surface of a head of the piston and an inner side wall of the cylinder head are provided with a coating film made of a material having a higher thermal conductivity at a lower temperature and a lower thermal conductivity at a higher temperature, thereby increasing heat transfer at an intake or compression stroke when temperature in the combustion chamber decreases and reducing heat transfer at an explosion or exhaust stroke when the temperature in the combustion chamber increases.

The coating film having variable properties may be made of a material comprising magnesium oxide (MgO).

The piston may be provided with a cooling passage through which a cooling fluid passes for cooling the piston and the cylinder head may be provided with a cooling water passage for cooling the cylinder head, wherein at the intake or compression stroke when the temperature in the combustion chamber decreases, the coating film has the higher thermal conductivity, thereby transferring heat in the combustion chamber to the piston cooled by the cooling fluid passed through the cooling passage and to the cylinder head cooled by water passed through the cooling water passage, and at the explosion or exhaust stroke when the temperature in the combustion chamber increases, the coating film has the lower thermal conductivity, thereby insulating or reducing the heat in the combustion chamber being transferred to the piston and the cylinder head.

The methods and apparatuses of the present invention have other features and advantages which will be apparent from or are set forth in more detail in the accompanying drawings, which are incorporated herein, and the following Detailed Description, which together serve to explain certain principles of the present invention.

### BRIEF DESCRIPTION OF THE DRAWINGS

FIG. 1 is a graph illustrating a change in temperature at the time of an operation of an engine.

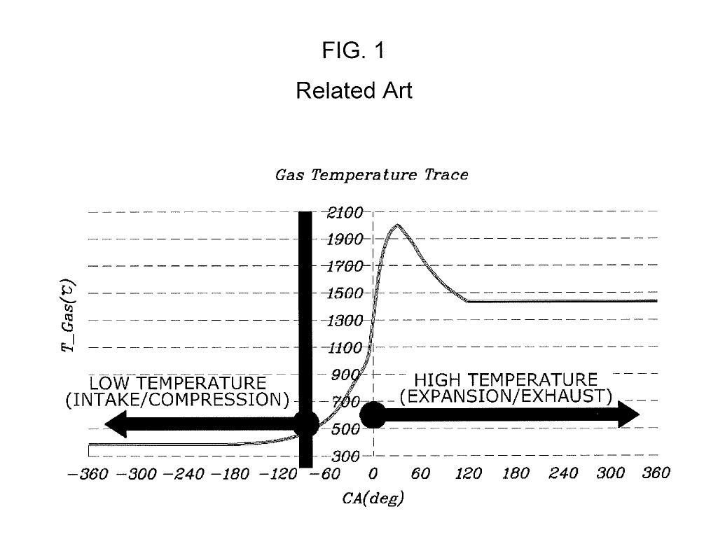

FIG. 2 is a diagram illustrating an engine for vehicles according to an exemplary embodiment of the present disclosure.

FIG. 3 is a diagram for describing the engine for vehicles illustrated in FIG. 2.

### DESCRIPTION OF SPECIFIC EMBODIMENTS

Reference will now be made in detail to various embodiments of the present invention(s), examples of which are illustrated in the accompanying drawings and described below. While the invention(s) will be described in conjunction with exemplary embodiments, it will be understood that present description is not intended to limit the invention(s) to those exemplary embodiments. On the contrary, the invention(s) is/are intended to cover not only the exemplary embodiments, but also various alternatives, modifications, equivalents and other embodiments, which may be included within the spirit and scope of the invention as defined by the appended claims.

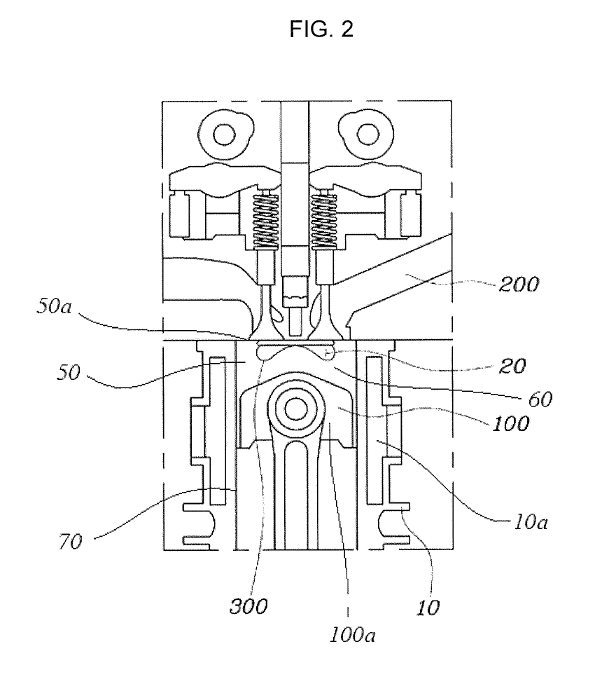

According to some exemplary embodiments of the present invention, as illustrated in FIG. 2, in an engine for vehicles including a piston 100 configured to be elevated or moved up and down within a cylinder 10 and a cylinder head 200 configured to be disposed over an upper portion 50 of the piston 100 to configure a combustion chamber 20 together with the piston 100, overheat due to high temperature and high pressure combustion gas which is generated within the combustion chamber 20 may be prevented and filling efficiency may be improved.

A structure of the cylinder 10 in which the piston 100 is mounted and the cylinder head are similar to or substantially the same as those in the related art. For example, an engine structure for vehicles as disclosed in “Korean Patent Laid Open Publication No. 10-2003-0077948” may be applied, the entire contents of which are incorporated herein for all purposes by this reference.

According to some exemplary embodiments of the present invention, it is possible to improve engine efficiency in consideration of temperature in the combustion chamber 20 which is changed due to the high temperature and high pressure combustion gas within the combustion chamber 20 which is configured to include the piston 100 and the cylinder head 200 and a change in temperature due to intake, compression, explosion, and exhaust strokes.

In detail, an upper surface 50a of a head 60 of the piston 100 and an inner side wall 70 of the cylinder head 200 are provided with a coating film 300 having variable properties which is made of a material having high thermal conductivity properties at a low temperature and low thermal conductivity properties at a high temperature. That is, the upper surface 50a of the head 60 of the piston 100 and the inner side wall 70 of the cylinder head 200 are a portion exposed to the combustion chamber 20 and the temperature in the combustion chamber 20 is changed due to the intake, compression, explosion, and exhaust strokes.

Therefore, the piston 100 and the cylinder head 200 are affected by the change in temperature in the combustion chamber 20. In particular, since the remaining heat remains in the combustion chamber 20 at the time of the intake stroke, the filling loss occurs due to the high heat capacity. Further, the high temperature and high pressure combustion gas is generated within the combustion chamber 20 at the time of the explosion stroke, and when a high-temperature heat source of the combustion gas is delivered to the piston 100 and the cylinder head 200, the cooling loss occurs.

To solve the above problem, as illustrated in FIG. 2, according to some exemplary embodiments of the present invention, the upper surface 50a of the head 60 of the piston 100 and the inner side wall 70 of the cylinder head 200 are provided with the coating film 300 having variable properties which is made of a material having the low thermal conductivity properties even at a high temperature.

That is, as the high temperature and high pressure combustion gas is emitted at the time of the intake stroke, the temperature in the combustion chamber 20 is relatively lower than the temperature at the time of the expansion stroke and as the high temperature and high pressure combustion gas is generated at the time of the expansion stroke, the temperature in the combustion chamber 20 is relatively higher than the temperature at the time of the intake stroke.

By using this, the upper surface 50a of the head 60 of the piston 100 and the inner side wall 70 of the cylinder head 200 are provided with the coating film 300 having variable properties, such that the thermal conductivity is increased due to the variable properties of the coating film 300 at the time of the intake stroke where the temperature in the combustion chamber 20 is relatively lower, thereby usefully exchanging heat between the combustion chamber 20 and the cylinder head 200 and the piston 100. Further, the thermal conductivity is reduced due to the variable properties of the coating film at the time of the expansion stroke where the temperature of the combustion chamber 20 is relatively increased and thus heat the heat exchange between the combustion chamber 20 and the cylinder head 200 and the piston 100 is blocked, thereby implementing the heat insulation.

As such, the heat source within the combustion chamber 20 is radiated through the piston 100 and the cylinder head 200 by the coating film 300 having variable properties at the time of the intake stroke and thus the temperature in the combustion chamber 20 is rapidly reduced, thereby preventing the filling efficiency from reducing due to the remaining heat in the combustion chamber 20 and heat is insulated so as to prevent the heat source within the combustion chamber 20 from being delivered to the piston 100 and the cylinder head 200, thereby preventing the temperature of the piston 100 and the cylinder head 200 from suddenly rising due the high-temperature heat source of the combustion gas.

The foregoing coating film 300 having variable properties may be formed to include magnesium oxide (MgO).

The thermal conductivity of magnesium oxide (MgO) is as shown in Table 1.

TABLE 1
Thermal Conductivity

| | Thermal |
|---|---|
| Temperature | Conductivity |
| (K) | (W m⁻¹ K⁻¹) |
| 400 | 29.4 |
| 450 | 26.6 |
| 500 | 23.8 |
| 550 | 21.6 |
| 600 | 19.7 |
| 650 | 18.3 |
| 700 | 16.6 |
| 750 | 15.3 |
| 800 | 14.3 |
| 850 | 13.1 |
| 900 | 12.3 |
| 950 | 11.7 |
| 1000 | 11.1 |
| 1050 | 10.5 |
| 1100 | 10.0 |
| 1150 | 9.5 |
| 1200 | 8.9 |
| 1250 | 8.3 |
| 1300 | 8.1 |

As such, the magnesium oxide (MgO) has properties in which the high thermal conductivity is shown at the low temperature but as the temperature is increased, the thermal conductivity is changed to be lowered. By using this, the MgO-based coating film 300 having variable properties is formed and then applied on the piston 100 and the cylinder head 200, and thus the cylinder head 200 and the piston 100 within the combustion 20 may have the high thermal conductivity at the low temperature and have the low thermal conductivity at the time of the high temperature.

In the case of the magnesium oxide (MgO), a content of the MgO is set to be 30 to 60% and a binder may consist of silicate or polyamideimide (PAI) and a coating thickness may be set to be 100 to 200 μm depending on a combination of the MgO and the binder. The MgO-based coating film 300 having variable characteristics may be set in consideration of the temperature value at the time of the intake stroke and the expansion stroke and the heat source delivered to the piston 100 and the cylinder head 200.

Meanwhile, the piston 100 is provided with a cooling passage 100a through which a cooling fluid may pass and thus may be configured to be cooled and the cylinder head 200 is provided with a cooling water passage 10a and thus may be configured to be cooled. As the temperature in the combustion chamber 20 is relatively reduced at the time of the intake/compression stroke, the coating film 300 having variable properties has the high thermal conductivity, and thus the heat in the combustion chamber 20 may be radiated due to cooling heat of the piston 100 and the cylinder head 200 and as the temperature in the combustion chamber 20 is relatively increased at the time of the expansion/exhaust stroke, the coating film 300 having variable properties has the low thermal conductivity, and thus the heat in the combustion chamber 20 may be insulated.

As such, the piston 100 is configured to be cooled by the cooling fluid and the cylinder 200 is also configured to be cooled by the cooling water, thereby controlling the temperature. The cooling structure of the piston 100 is as disclosed in “Korean Patent No. 10-0827492” and a cooling structure of the cylinder head 200 is as disclosed in “Korean Patent Laid-Open Publication No. 2003-0077948”, the entire contents of which are incorporated herein for all purposes by this reference. As such, the cooling structure of the piston 100 and the cylinder head 200 are known in the related art document and therefore the detailed description thereof will be omitted.

As described above, as the piston 100 and the cylinder head 200 are configured to be cooled, the temperature is controlled so that the head of the piston 100 and the cylinder head 200 are not damaged by overheat due to the high-temperature heat source of the combustion gas generated from the combustion gas 20.

In particular, according to some exemplary embodiments of the present invention, the upper surface 50a of the head 60 of the piston 100 and the inner side wall 70 of the cylinder head 200 which are exposed to the combustion chamber 20 are provided with the coating film 300 having variable properties, thereby controlling the heat exchange between the high-temperature heat source of the combustion chamber 20 and the piston 100 and the cylinder head 200.

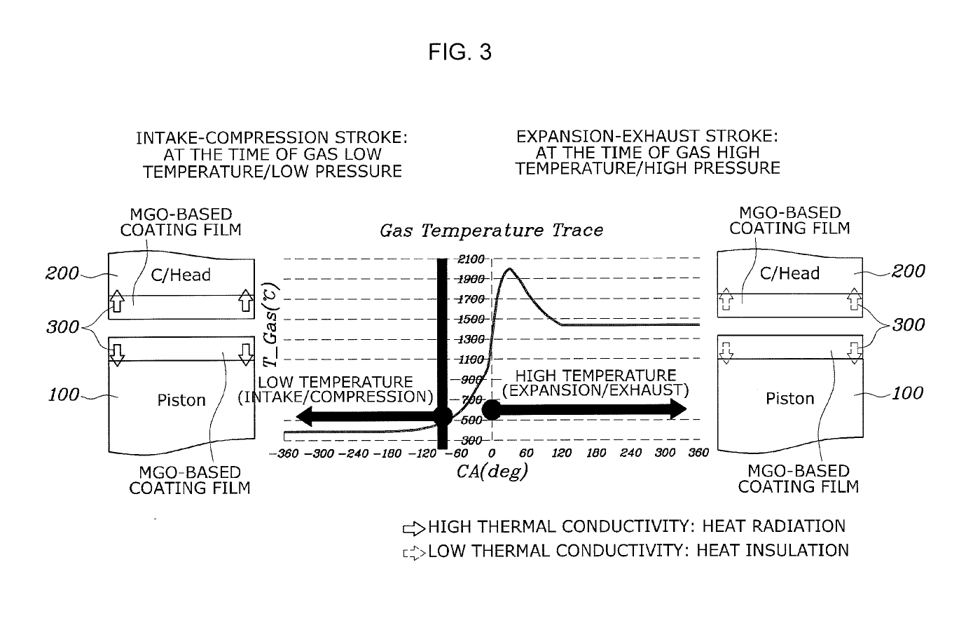

In detail, as illustrated in FIG. 3, at the time of the intake/compression stroke, the temperature of the combustion chamber 20 is relatively lower than that at the time of the expansion/exhaust stroke, and thus the thermal conductivity of the coating film 300 having variable properties is increased, such that the heat in the combustion chamber 20 is exchanged with the cooling heat depending on the cooling structure of the piston 100 and the cylinder head 200. As such, the high-temperature heat source in the combustion chamber 20 at the time of the intake/compression stroke is exchanged with the cooling structure of the piston 100 and the cylinder head 200 and is thus radiated, such that the remaining heat in the combustion chamber 20 is reduced, thereby improving the filling efficiency.

Further, as the temperature in the combustion chamber 20 at the time of the expansion/exhaust stroke is relatively higher than that at the time of the intake/compression stroke, the coating film 300 having variable properties has the low thermal conductivity and thus the heat in the combustion chamber 20 is prevented from being delivered to the piston 100 and the cylinder head 200 side. As such, at the time of the expansion/exhaust stroke, the high-temperature heat source in the combustion chamber 20 is insulated by the coating film 300 having variable properties which is applied to the piston 100 and the cylinder head 200 and thus the high heat of the combustion gas is delivered to the cooling fluid of the piston 100 and the cooling water of the cylinder head 200, thereby preventing the cooling efficiency from reducing. Therefore, the temperature of the piston 100 and the cylinder head 200 may be smoothly performed and the cooling efficiency may be improved.

According to the engine for vehicles having the foregoing or similar structure, the heat in the combustion chamber 20 may be radiated or insulated depending on the temperature condition of the engine combustion chamber 20. In particular, the heat in the combustion chamber 20 is radiated or insulated depending on the temperature condition at the time of the intake, compression, expansion, and exhaust strokes, and as a result, the filling efficiency may be improved at the time of the intake stroke which is the low temperature condition and the cooling efficiency may be improved at the time of the expansion stroke which is the high temperature condition.

According to the engine for vehicles having the foregoing or similar structure, the heat in the combustion chamber may be radiated or insulated depending on the temperature condition of the engine combustion chamber.

That is, it is possible to improve the filling efficiency under the condition in which the temperature in the engine combustion chamber is low and the cooling efficiency under the condition in which the temperature in the engine combustion chamber is high.

For convenience in explanation and accurate definition in the appended claims, the terms “up” or “down”, “higher” or “lower”, and etc. are used to describe features of the exemplary embodiments with reference to the positions of such features as displayed in the figures.

The foregoing descriptions of specific exemplary embodiments of the present invention have been presented for purposes of illustration and description. They are not intended to be exhaustive or to limit the invention to the precise forms disclosed, and obviously many modifications and variations are possible in light of the above teachings. The exemplary embodiments were chosen and described in order to explain certain principles of the invention and their practical application, to thereby enable others skilled in the art to make and utilize various exemplary embodiments of the present invention, as well as various alternatives and modifications thereof. It is intended that the scope of the invention be defined by the Claims appended hereto and their equivalents.

What is claimed is:

1. An engine for vehicles, comprising:
a piston provided to be moved up and down within a cylinder; and
a cylinder head disposed over an upper portion of the piston to form a combustion chamber together with the piston,
wherein an upper surface of a head of the piston and an inner side wall of the cylinder head are provided with a coating film made of a material having a higher thermal conductivity at a lower temperature and a lower thermal conductivity at a higher temperature, thereby increasing heat transfer at an intake or compression stroke when temperature in the combustion chamber decreases and reducing heat transfer at an explosion or exhaust stroke when the temperature in the combustion chamber increases.

2. The engine of claim 1, wherein the coating film is made of a material comprising magnesium oxide (MgO).

3. The engine of claim 1, wherein:
the piston is provided with a cooling passage through which a cooling fluid passes for cooling the piston; and
the cylinder head is provided with a cooling water passage for cooling the cylinder head, wherein
at the intake or compression stroke when the temperature in the combustion chamber decreases, the coating film has the higher thermal conductivity, thereby transferring heat in the combustion chamber to the piston cooled by the cooling fluid passed through the cooling passage and to the cylinder head cooled by water passed through the cooling water passage, and
at the explosion or exhaust stroke when the temperature in the combustion chamber increases, the coating film has the lower thermal conductivity, thereby insulating or reducing the heat in the combustion chamber being transferred to the piston and the cylinder head.
